(19) United States
(12) Patent Application Publication
(10) Pub. No.: US 2006/0002382 A1
(43) Pub. Date: Jan. 5, 2006

(54) System and method for establishing calls over dynamic virtual circuit connections in an ATM network

(76) Inventor: Daniel M. Cohn, Plano, TX (US)

Correspondence Address: Bruce E. Garlick;Garlick Harrison & Markison, LLP, P.O. Box 167027, Austin, TX, 78716-0727, US

(21) Appl. No.: 10/881,283

(22) Filed: Jun. 30, 2004

(51) Int. Cl. H04L 12/66

(52) U.S. Cl. 370/356; 370/522

(57) ABSTRACT

A cellular wireless core network for establishing calls via dynamic virtual circuit connections includes a source call server exchanging messages with a destination call server in order to determine a destination media gateway. The destination media gateway determines a destination logical ATM component and its logical ATM component address. The destination media gateway returns the destination logical ATM component address to the destination call server, which, in turn, returns the destination logical ATM component address to the source call server. The source call server forwards the destination logical ATM component address to a source logical ATM component. The source logical ATM component sends an Establish Request (ERQ) message to the destination logical ATM component containing the destination logical ATM component address, the source logical ATM component address, and a virtual circuit connection identifier that uniquely defines the virtual connection through the ATM network.

### BACKGROUND OF THE INVENTION

1. Technical Field of the Invention

This invention relates generally to wireless communication systems and, more particularly, to wired infrastructure networks used therein.

2. Description of Related Art

Initial wireless voice networks, including Advanced Mobile Phone Service (AMPS), Time Division Multiple Access (TDMA), including North American TDMA and Global System for Mobile Communications (GSM) networks, were used to carry wireless calls for a limited number of users and primarily only for voice calls. Cellular wireless networks are currently being replaced by newer wireless data-only or data-centric networks, as well as mixed data and voice networks as the wireless technology grows in popularity. The structure and operation of wireless communication systems are generally known. Examples of such wireless communication systems include cellular systems and wireless local area networks, among others. Equipment that is deployed in these communication systems is typically built to support standardized operations, i.e., operating standards. These operating standards prescribe particular carrier frequencies, modulation types, baud rates, physical layer frame structures, medium access control (MAC) layer operations, link layer operations, signaling protocols, etc. By complying with these operating standards, equipment interoperability is achieved.

In cellular systems, a plurality of base stations is distributed across the service area. Each base station services wireless communications within a respective cell. Each cell may be further subdivided into a plurality of sectors. In many cellular systems, e.g., GSM cellular systems, each base station supports forward link communications (from the base station to subscriber units) on a first set of carrier frequencies, and reverse link communications (from subscriber units to the base station) on a second set of carrier frequencies. The first set and second set of carrier frequencies supported by the base station are a subset of all of the carriers within the licensed frequency spectrum. In most, if not all, cellular systems, carrier frequencies are reused so that interference between base stations using the same carrier frequencies is minimized and system capacity is increased. Typically, base stations using the same carrier frequencies are geographically separated so that minimal interference results. In other cellular systems, such as CDMA systems, a single frequency is used to carry code divided communications.

Traditional wireless mobile networks include Mobile Switching Centers (MSCs), Base Station Controllers (BSCs) and Base Station Transceiver Sets (BTSs), which jointly operate to communicate with mobile stations over a wireless communication link. The BSCs and BTSs collectively are referred to as BSs or base stations. To establish a wireless communication link in traditional wireless voice networks, the MSC communicates with the BSC to prompt the BTS to generate paging signals to a specified mobile station within a defined service area typically known as a cell or sector (a cell portion). The mobile station, upon receiving the page request from the BTS, responds to indicate that it is present and available to accept an incoming call. Thereafter, the BS, upon receiving a response from the mobile station, communicates with the MSC to advise it of the same. The call is then routed through the BS to the mobile station as the call setup is completed and the communication link is created. Alternatively, to establish a call, a mobile station generates call setup signals that are processed by various network elements in a synchronized manner to authenticate the user as a part of placing the call.

Wireless communication service providers, as well as Internet service providers, are increasingly working together to provide seamless end-to-end call connectivity across the various platforms to enable users to establish point-to-point connections independent of terminal type and location. Traditionally, however, voice networks have paved the way for the creation of data networks as users loaded the voice networks trying to transmit data, including streaming data (video and audio). Initially, traditional Public Switched Telephone Networks (PSTNs) were used for data transmissions but have been largely supplanted by packet data networks, including various versions of the Internet. The next generation of cellular networks presently being developed is being modified from traditional systems to create the ability for mobile stations to receive and transmit data in a manner that provides greatly increased throughput rates. For example, many new mobile stations, often referred to as mobile terminals or access terminals, are being developed to enable a user to surf the web or send and receive e-mail messages through the wireless channel, as well as to be able to receive continuous bit rate data, including so called “streaming data” such as sports and news. Accordingly, different systems and networks are being developed to expand capabilities to include streaming data, video conferencing, wireless file and image transfer and instant text messaging.

Cellular wireless core networks service the large amount of data now being transferred between BSCs, between BSCs and the Internet, and between various other cellular wireless network components. One common type of core network is a combination of a traffic network, e.g., Asynchronous Transfer Mode (ATM) network, and a signaling network, e.g., Signaling System 7 (SS7) network. This network structure is used commonly in not only cellular wireless networks but in other networks as well, e.g., the PSTN, private networks, and other networks. With this network structure, media gateways serve as both traffic and signaling endpoints for transaction setup and servicing. Each media gateway typically is assigned a unique signaling network point code.

Problems arise with this network structure when multiple bearer ATM network nodes are associated with a single signaling network point code. Such is the case because legacy signaling networks associate a single signaling network point code with a single ATM network node address so that virtual circuit connections established through the ATM network have unique identifiers. When multiple ATM network addresses are associated with a single signaling network point code for network expansion reasons, virtual circuit connection identifiers are no longer unique. This may happen when a single media gateway is expanded with multiple blades or logical ATM components, each having separate ATM addresses. A need exists, therefore, for a system and method to generate unique virtual circuit connection identifiers for signaling network point codes that have multiple ATM addresses associated therewith.

### BRIEF SUMMARY OF THE INVENTION

A method and system for establishing calls over a dynamic virtual circuit connection overcomes the above-cited, among other shortcomings. The method in a cellular wireless core network for establishing the dynamic virtual circuit connection to service a call includes a source call server exchanging signaling messages with a destination call server in order for the destination call server to determine a destination media gateway. The source media gateway and the destination media gateway define the beginning and the end, respectively, of the dynamic virtual circuit connection. Thereafter, the destination media gateway determines, based on load factors or statistical modeling, a destination logical ATM component and its logical ATM component address corresponding to the destination logical ATM component from a plurality of logical ATM components installed in the destination media gateway. Each of the plurality of logical ATM components has a unique ATM end station address. The destination media gateway returns the destination logical ATM component address to the destination call server, which, in turn, returns the destination logical ATM component address to the source call server.

The source call server sends the destination logical ATM component address to the source media gateway that further sends the destination logical ATM component address to a source logical ATM component selected from a plurality of logical ATM components. Once the destination logical ATM component address is known, a dynamic virtual circuit connection can be established between the source and the destination. The source logical ATM component sends a signaling message to the destination logical ATM component containing the destination logical ATM component address, the source logical ATM component address, and a virtual circuit connection identifier that uniquely defines the virtual path and virtual channel through the ATM network.

Thereafter, the destination logical ATM component returns a signaling message to the source logical ATM component that verifies the dynamic virtual circuit connection between the source logical ATM component establishing the call and the destination logical ATM component. Thereafter, the source logical ATM component and the destination logical ATM component begin servicing the call via the dynamic virtual circuit connection.

A cellular core network system for establishing dynamic virtual circuit connections comprises an ATM traffic network, a signaling network, a source call server, and a destination call server. The ATM traffic network includes a plurality of media gateways, each media gateway having a plurality of logical ATM components, each logical ATM component having a logical ATM component address. The signaling network includes the plurality of media gateways, each of the media gateways having a respective signaling endpoint code. The source call server and a destination call server are operable to determine a source media gateway and a destination media gateway from the plurality of media gateways.

The destination media gateway is operable to determine a destination logical ATM component from a plurality of logical ATM components and a destination logical ATM component address corresponding to the destination logical ATM component and to return the destination logical ATM component address to the destination call server. The destination call server is operable to return the destination logical ATM component address to the source call server wherein the source call server forwards the address to the source media gateway which, in turn, forwards the destination logical ATM component address to a source logical ATM component. Once the destination address is known, the dynamic virtual circuit connection is defined. The source logical ATM component then sends a message to the destination logical ATM component wherein the message includes the logical ATM component address of the source and destination logical ATM component as well as a path identifier that defines the logical path through the ATM network. In response to the message, the destination logical ATM component returns a confirmation message to the source logical ATM component. At this point, the source logical ATM component and the destination logical ATM component are operable to service a call via a dynamic virtual circuit connection.

The above-referenced description of the summary of the invention captures some, but not all, of the various aspects of the present invention. The claims are directed to some of the various other embodiments of the subject matter towards which the present invention is directed. In addition, other aspects, advantages and novel features of the invention will become apparent from the following detailed description of the invention when considered in conjunction with the accompanying drawings.

### BRIEF DESCRIPTION OF THE SEVERAL VIEWS OF THE DRAWINGS

FIG. 1 is a functional block diagram illustrating a communication network formed according to one embodiment of the present invention;

FIG. 2 is a functional block diagram illustrating a formatted ATM cell transmitted over a dynamic virtual circuit connection in accordance with the present invention;

FIG. 3 is a functional block diagram illustrating establishing calls over dynamic virtual circuit connections in accordance with an embodiment of the present invention;

FIG. 4 is a message flow diagram illustrating signal sequence flow for establishing calls over dynamic virtual circuit connections in accordance with an embodiment of the present invention; and

FIG. 5 is a flow chart illustrating one method of the present invention.

### DETAILED DESCRIPTION OF THE INVENTION

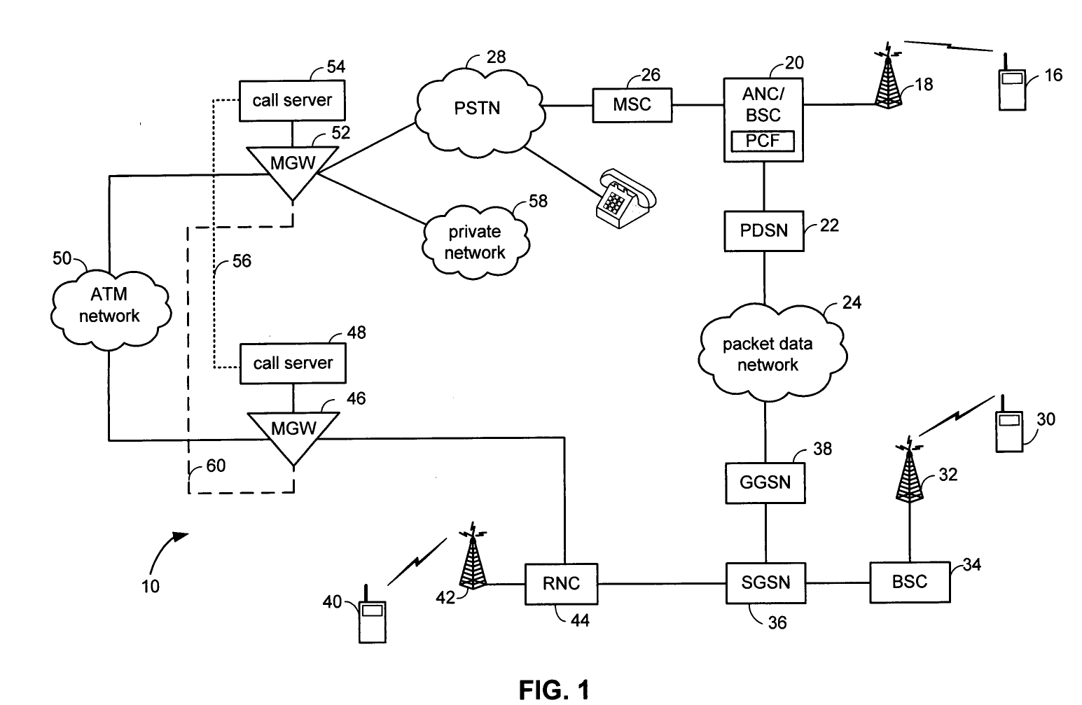

FIG. 1 is a functional block diagram illustrating a communication network formed according to one embodiment of the present invention. As may be seen, a communication network 10 includes many networks that are coupled to operatively communicate with each other to enable a user in one type of network to communicate with a user in a different type of network. For example, communication network 10 creates an ability for a wire line user terminal coupled to the public switched telephone network to communicate with a mobile terminal through a wireless communication link. Such transparent operation with respect to the user is improving access to information and the ability for individuals to communicate to a level that is unprecedented. Existing wireless networks have been adapted primarily for carrying voice calls. Accordingly, when used in conjunction with a computer terminal, the wireless voice networks were able to transmit or receive data at rates that today are viewed as unacceptably slow although they were appreciated at the outset.

Along these lines, a mobile station 16 is located within a geographic area served by a Base Transceiver Station (BTS) 18 that is coupled to an Access Network Controller/Base Station Controller (ANC/BSC) 20. Mobile station 16 is engaged in a voice call, as defined by a service option generated during call setup so the wireless communication link is transmitting only voice signals and associated control signaling.

Continuing to examine FIG. 1, BTS 18 is generally coupled to communicate with ANC/BSC 20 (or with packet control function cards there within). Within ANC/BSC 20, a plurality of different wireless network cards may be included to facilitate communications with mobile stations of differing protocols and types. For example, ANC/BSC 20 includes circuitry to communicate with mobile station 16 over an IS-95 wireless communication network link. As is understood by one of average skill in the art, access network controllers and base station controllers have similar functionality. As is further understood, the BSC and ANC elements may readily be formed as stand alone units, but are shown herein as combined systems for illustration.

A Packet Control Function (PCF) is shown installed within either the BSC or the ANC comprising ANC/BSC 20 according to the protocol of the device communicating with the PCF. Packet data calls processed by the PCF installed in ANC/BSC 20 are forwarded through Packet Data Serving Node (PDSN) 22, which, after authentication, is connected to packet data network 24.

ANC/BSC 20 is also coupled to MSC 26 in order to route calls to other networks through other MSCs (not shown) or to the Public Switched Telephone Network (PSTN) 28.

A Global System for Mobile Communications (GSM) mobile terminal 30 is coupled to packet data network 24 by way of BSC 34. Unlike circuit-switched data calls that are connected to voice networks by the mobile switching center, General Packet Radio Service (GPRS) packets are sent from BSC 34 to Serving GPRS Support Node (SGSN) 36. The SGSN is a node within the GSM infrastructure that sends and receives data to and from the mobile stations. It also keeps track of the mobile stations within its service area. SGSN 36 communicates with a Gateway GPRS Support Node (GGSN) 38, a system that maintains connections with other networks such as packet data network 24, X.25 networks or private networks. As shown in FIG. 1, GGSN 38 forms a gateway between packet data network 24 and the GPRS network that is presently serving mobile station 30. A GPRS network can use multiple serving nodes, but requires only one gateway node for connecting to an external network such as packet data network 24.

Continuing to refer to FIG. 1, mobile terminal 40 is transmitting voice and data in a UMTS compliant network. Radio Network Controller (RNC) 44 controls radio resources in the area served by tower 42. The RNC is functionally equivalent to the BSC in the GSM/GPRS network. The UMTS standard adopted the ATM transport layer as the transmission backbone to have the flexibly to adapt to different types of multimedia traffic. The ATM Adaptation Layer (AAL) provides support for mapping multimedia traffic between the ATM layer and the non-ATM application using the ATM layer. Various AAL layers exist to support diverse data types over the ATM network. One such layer, AAL2, was designed to support packetized voice and data over ATM. It can multiplex different users' traffic into the ATM cell by putting packets from different users in the same cell and by dividing a user packet between two or more cells. This is an efficient method to deal with bursty multimedia traffic.

The RNC 44 routes voice call to SGSN 36 or routes multimedia traffic to Media Gateway (MGW) 46 for delivery to MGW 52 over ATM network 50. Media gateways act as translators between disparate telecommunications networks such as UMTS, PSTN 28, and private network 58. The media gateway is controlled by a call server that provides the control and signaling necessary to establish communications between media gateways. As can be seen in FIG. 1, MGW 46 is controlled by call server 48 while MGW 52 is controlled by call server 54.

Prior to transmission of the multimedia traffic, call set up signaling 56 between call server 48 (the source call server) and call server 54 (the destination call server) establishes a call between MGW 46 and MGW 52. Signaling 60 between MGW 46 and MGW 52 sets up the VCC through ATM network 50. Previously, only one media gateway having an ATM service endpoint address was associated with a signaling point code in the signaling network (SS7 for example) thus a Virtual Circuit Connection Identifier (VCCI) uniquely identified the VCC established between a pair of nodes in the ATM network. However, when multiple media gateways (or multiple ATM interface cards in a media gateway), each having an ATM End Station Address (AESA), are associated with one signaling point code the VCCI no longer uniquely identifies the VCC. The method and system of the present invention solve this problem by inserting the source and destination AESAs along with the VCCI into the signaling messages to uniquely identify the VCC.

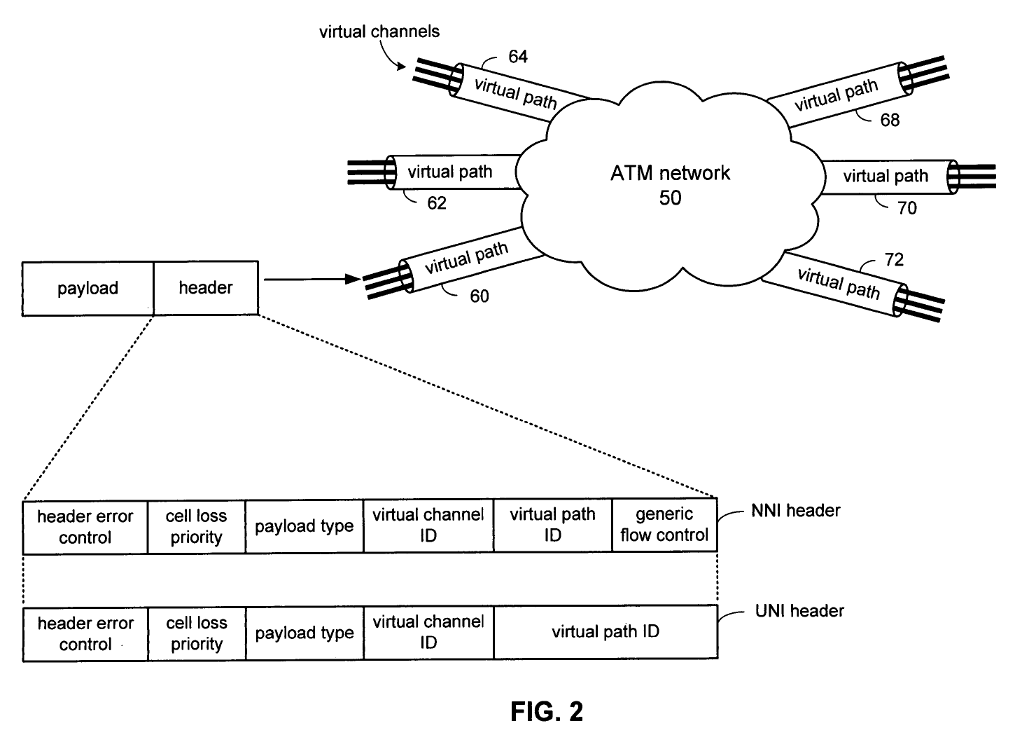

FIG. 2 is a functional block diagram illustrating a formatted ATM cell transmitted over a dynamic virtual circuit connection in accordance with the present invention. ATM is a high-speed connection based packet switching network. Data transmitted over the ATM network is divided into fixed length data packets called cells. The ATM cell has a fixed length of 53 octets that includes a five octet header and a 48 octet payload. Before cells can be transmitted, a virtual circuit connection must be established between the source and destination. As shown in FIG. 2, ATM network 50 includes a plurality of virtual paths, namely virtual paths 60-72. Each virtual path includes a plurality of virtual channels. ATM network nodes (media gateways for example) exchange signaling messages across the ATM network to establish the virtual circuit connection. The establishment of a dynamic virtual circuit connection identifies the virtual path and the virtual channel connecting the two end points (the source and the destination) of the dynamic virtual circuit connection. Once the virtual circuit connection is completed, calls may be routed through the ATM network.

The ATM network consists of ATM switches interconnected by point-to-point ATM interfaces. There are two types of interfaces: a user-network interface (UNI) and a network-network interface (NNI). UNIs connect ATM switches to end devices such as routers while NNIs generally connect two ATM switches. Due to the difference in the two types of interfaces, the UNI and NNI headers differ slightly. The UNI header ensures correct routing and data reception and includes fields for generic flow control, virtual path ID, virtual channel ID, payload type, cell loss priority, and header error control. The generic flow control field is used to provide a flow control mechanism for the ATM network. The virtual path ID and the virtual channel ID identify the virtual path and virtual channel established through the ATM network from the source to the destination or from one ATM node to the next ATM node when multiple ATM nodes connect the source to the destination.

These numbers are stored in the respective header fields to identify the proper routing through the ATM network. One advantage of ATM is that the network can transport any type of data such as data, voice, and video. The payload field identifies the type of data in the cell. Cell loss priority is used to deal with network congestion and the header error control is used to correct single bit errors and to detect multi-bit errors. The Network Node Interface (NNI) also has a five octet header but eliminates the generic flow control field. The four bits from this field are used to expand the virtual path ID. All other functions are identical.

Each virtual path through ATM network 50 includes a plurality of virtual channels. One aspect of the present invention is to establish a dynamic virtual circuit connection through the ATM network with a unique identifier when multiple media gateways represent a single signaling point code.

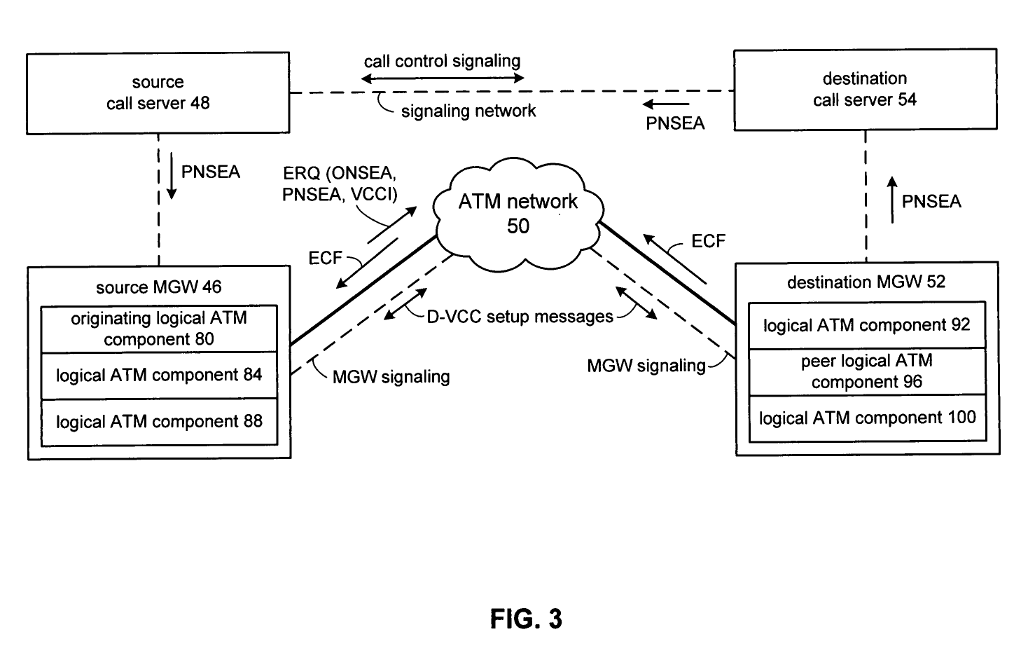

FIG. 3 is a functional block diagram illustrating establishing calls over dynamic virtual circuit connections in accordance with an embodiment of the present invention. When a call is placed, the originating or source call server controlling the source media gateway determines the destination call server that controls the destination media gateway. Call control signaling messages sent over a signaling network provide the call control management while MGW signaling exchanges Dynamic VCC (D-VCC) setup messages to establish a dynamic virtual circuit connection between the source and destination MGWs over the ATM network. It is understood by one of average skill in the art that a call server may control multiple MGWs and it is further understood that the dynamic virtual circuit connection may be established between two MGWs controlled by the same call server. Although, in this situation, the source and destination call server are the same, the methods of the present invention are still applicable. In the example of FIG. 3, source call server 48 sends call control signaling messages to destination call server 54. Destination call server 54 signals destination MGW 52 for the address of the logical ATM component selected to handle the call. Source MGW 46 and destination MGW 52 each include a plurality of logical ATM components, namely components 80-88 and 92-100, having a unique ATM End Station Address (AESA). The method of the present invention uniquely identifies the VCC when a plurality of ATM ESAs is associated with a single signaling network point code. Destination MGW 52 selects a logical ATM component from the plurality of logical ATM components to serve as the ATM destination node, designated as peer logical ATM component 96 in FIG. 3. Destination MGW 52 returns the AESA of peer logical ATM component 96 as the Peer Network Service Endpoint Address (PNSEA) to destination call server 54 which, in turn, returns the PNSEA to source call server 48.

Subsequently, source call server 48 forwards the PNSEA to source MGW 46. Source MGW 46 selects one of the plurality of logical ATM components as the source or origin of the VCC. Thereafter, originating logical ATM component 80 sends an Establish Request (ERQ) message containing the PNSEA, the VCCI, and the Originating NSEA (ONSEA) that uniquely define the dynamic virtual circuit connection. The addition of the ONSEA and PNSEA in the ERQ message enables the destination media gateway to route the message to the peer logical ATM component and enables the destination media gateway to identify the source of the VCC. After receiving the ERQ message, destination MGW 52 returns an Establish Confirm (ECF) message to source MGW 46 to complete the dynamic virtual circuit connection. Thereafter, originating logical ATM component 80 begins transmitting cells to peer logical ATM component 96. The dynamic virtual circuit connection is maintained until the call or series of calls are completed then the dynamic virtual circuit connection is torn down to release the resources.

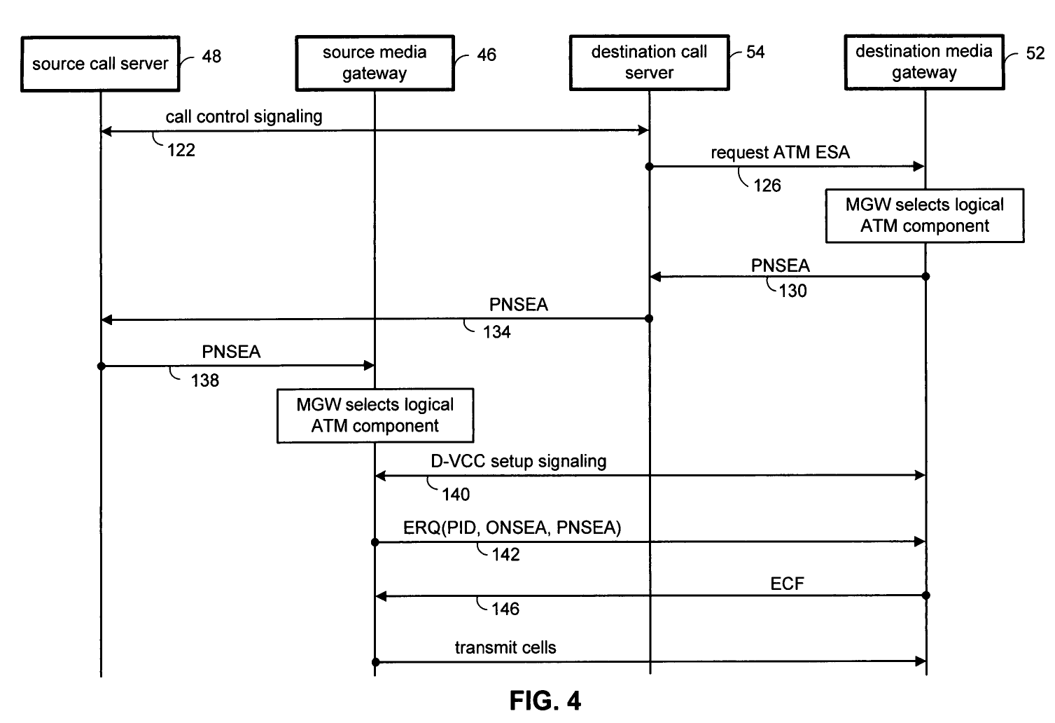

FIG. 4 is an example message flow diagram illustrating signal sequence flow for establishing calls via dynamic virtual circuit connections in accordance with an embodiment of the present invention. Before cells can be transmitted, the dynamic virtual circuit connection must be established through the network. Source call server 48 communicates with destination call server 54 by call control signaling 122. Destination call server 54 identifies destination media gateway 52 as the connection end point and requests, by way of message 126, the ATM end station address of the logical ATM component that will complete the dynamic virtual circuit connection. As was previously mentioned, destination media gateway 52 includes a plurality of logical ATM components having unique ATM end station addresses associated with the signaling network signaling point code. Destination media gateway 52 selects a logical ATM component and returns, by way of message 130, the unique Peer Network Service Endpoint Address (PNSEA) of the of the logical ATM component that will complete the dynamic virtual circuit connection.

Similarly, source call server 48 identifies source media gateway 46 as the connection start point. Source media gateway 46 selects a source or originating logical ATM component and generates a unique Originating NSEA (ONSEA) for the originating logical ATM component that will start the dynamic virtual circuit connection.

Destination call server 54 returns the PNSEA received from destination media gateway 52 to source call server 48 by way of message 134. Source call server 48 then forwards the received PNSEA to source media gateway 46 by way of message 138. When source media gateway 46 receives the PNSEA, it exchanges Dynamic Virtual Circuit Connection (D-VCC) setup signaling messages 140 with destination media gateway 52. Once the source media gateway has the source and destination network addresses, an Establish Request (ERQ) is transmitted to the destination media gateway by message 142. The ERQ includes the ONSEA, the PNSEA, and the Path ID (PID), which uniquely identifies the dynamic virtual circuit connection. On receipt of the Establish Confirm (ECF), as indicated by signaling line 146, the media gateways begin transferring cells.

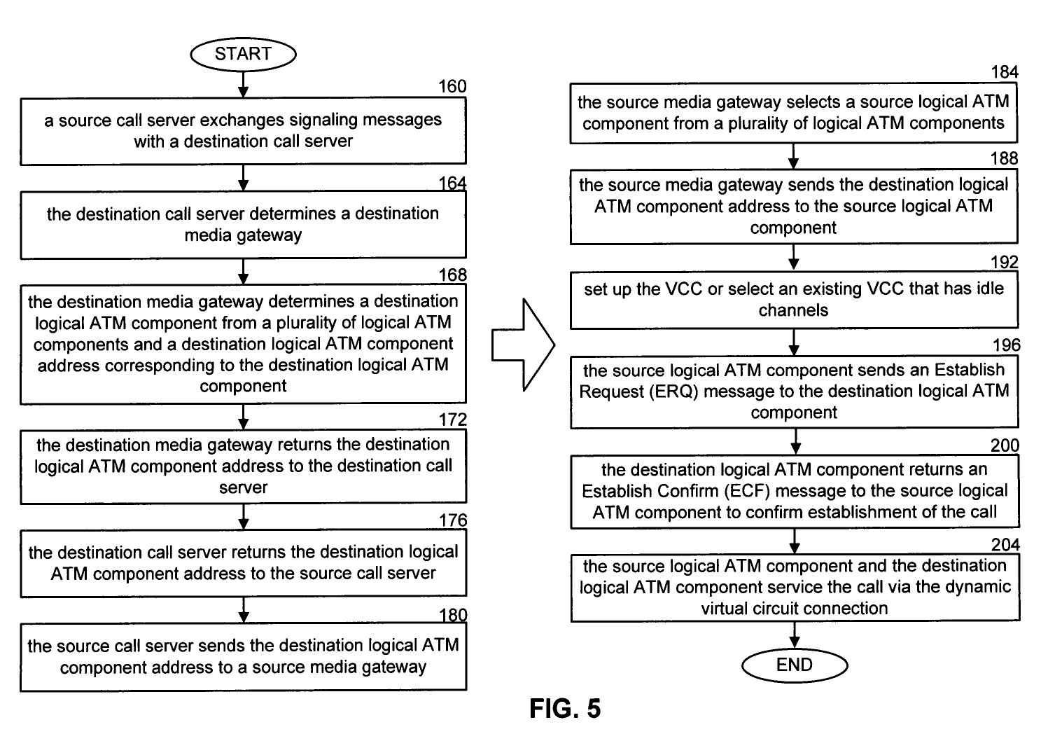

FIG. 5 is a flow chart illustrating one method of the present invention. In a cellular wireless core network, the method for establishing calls over dynamic virtual circuit connections includes a source call server exchanging signaling messages with a destination call server (step 160). Call servers control the media gateways and control the call processing. To complete a call, a dynamic virtual circuit connection must be established between a source and a destination that represents the start and end point, respectively, in the ATM network. The destination call server determines a destination media gateway (step 164) based on criteria such as current loading factors or statistical methods. Similarly, the source call server determines a source media gateway to handle the call. Each media gateway includes a plurality of logical ATM components having unique ATM end station addresses thus the destination media gateway determines a destination logical ATM component from a plurality of logical ATM components and a destination logical ATM component address corresponding to the destination logical ATM component (step 168). The address of the destination logical ATM component or peer logical ATM component address is identified by the PNSEA. Thereafter, the destination media gateway returns the destination logical ATM component address to the destination call server (step 172). Then, the destination call server returns the destination logical ATM component address (defined as PNSEA) to the source call server (step 176) wherein the source call server sends the destination logical ATM component address to a source media gateway (step 180). The source media gateway selects a source logical ATM component from a plurality of logical ATM components (step 184). Then, the source media gateway sends the destination logical ATM component address to the source logical ATM (step 188). Thereafter, the media gateways sets up the VCC or selects an existing VCC that has idle channels (step 192). The source logical ATM component selected from the plurality of logical ATM components is identified as the originating logical ATM component and the source logical ATM component address is identified as the ONSEA. Having identified the source and destination endpoints of the dynamic virtual circuit connection, the source logical ATM component sends an Establish Request (ERQ) message to the destination logical ATM component (step 196) that includes the ONSEA, the PNSEA, and the PID that uniquely identifies the dynamic virtual circuit connection through the ATM network. The destination logical ATM component returns an Establish Confirm (ECF) message to the source logical ATM component to confirm the establishment of the dynamic virtual circuit connection (step 200) then source logical ATM component and the destination logical ATM component service the call via the dynamic virtual circuit connection (step 204).

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The invention disclosed herein is susceptible to various modifications and alternative forms. Specific embodiments therefore have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

What is claimed is:

1. A method in a cellular wireless core network for utilizing a dynamic virtual circuit connection to service a call comprises:
a source call server exchanging signaling messages with a destination call server;
the destination call server determining a destination media gateway;
the destination media gateway determining a destination logical ATM component from a plurality of logical ATM components and a destination logical ATM component address corresponding to the destination logical ATM component;
the destination media gateway returning the destination logical ATM component address to the destination call server;
the destination call server returning the destination logical ATM component address to the source call server;
the source call server sending the destination logical ATM component address to a source media gateway;
the source media gateway selecting a source logical ATM component from a plurality of logical ATM components;
the source media gateway sending the destination logical ATM component address to the source logical ATM component;
the source logical ATM component sending an Establish Request (ERQ) message to the destination logical ATM component;
the destination logical ATM component returning an Establish Confirm (ECF) message to the source logical ATM component to confirm establishment of the call; and
the source logical ATM component and the destination logical ATM component servicing the call via the dynamic virtual circuit connection.

2. The method of claim 1 wherein the ERQ message comprises:
the source media gateway assigned Originating Network Service Endpoint Address (ONSEA).

3. The method of claim 2 wherein the ERQ message further comprises:
the destination media gateway assigned Peer Network Service Endpoint Address (PNSEA).

4. The method of claim 3 wherein the destination media gateway determining the destination logical ATM component further comprises:
assigning a Virtual Circuit Connection Identifier (VCCI) to the path between the source logical ATM component and the destination logical ATM component.

5. The method of claim 4 wherein the VCCI, the ONSEA, and the PNSEA define a unique path through the ATM network.

6. The method of claim 1, wherein the cellular wireless core network comprises a UMTS R4 core network.

7. The method of claim 1, wherein:
the source media gateway has assigned thereto a unique point code within a coupling packet switched signaling network;
a first plurality of logical ATM components, each with a corresponding ATM identity, is uniquely associated with the unique point code of the source media gateway;
the destination media gateway has assigned thereto a unique point code within the coupling packet switched signaling network; and
a second plurality of logical ATM components, each with a corresponding ATM identity, is uniquely associated with the unique point code of the destination media gateway.

8. A cellular core network system comprises:
an Asynchronous Transfer Mode (ATM) traffic network that includes a plurality of media gateways, each media gateway having a plurality of logical ATM components, each logical ATM component having a logical ATM component address;
a signaling network that includes the plurality of media gateways, each of the media gateways having a respective signaling endpoint code;
a source call server and a destination call server operable to determine a source media gateway and a destination media gateway from the plurality of media gateways;
the destination media gateway operable to determine a destination logical ATM component from the plurality of logical ATM components and a destination logical ATM component address corresponding to the destination logical ATM component;
the destination media gateway operable to return the destination logical ATM component address to the destination call server;
the destination call server operable to return the destination logical ATM component address to the source call server;
the source media gateway operable to forward the destination logical ATM component address to a source logical ATM component;
the source logical ATM component operable to send an Establish Request (ERQ) message to the destination logical ATM component;
the destination logical ATM component operable to return an Establish Confirm (ECF) message to the source logical ATM component; and
the source logical ATM component and the destination logical ATM component operable to service a call via a dynamic Virtual Circuit Connection (VCC).

9. The cellular core network system of claim 8 wherein each of the plurality of media gateways comprises a plurality of ATM processing elements, each ATM processing element corresponding to a separate logical ATM component, wherein each ATM processing element has a unique logical ATM component address.

10. The cellular core network system of claim 9 wherein each unique logical ATM component address comprises a unique ATM Network Service Endpoint Point (NSEA).

11. The cellular core network system of claim 8 wherein a source entity selects the source logical ATM component to host the dynamic VCC, and wherein the source entity generates an Originating NSEA (ONSEA) representing a NSEA of the source logical ATM component.

12. The cellular core network system of claim 11 wherein the source entity comprises one of a source media gateway, a source call server, and a source controller.

13. The cellular core network system of claim 11 wherein a destination entity selects the destination logical ATM component to host the dynamic VCC, and wherein the destination entity generates a Peer NSEA (PNSEA) representing the NSEA of the destination logical ATM component.

14. The cellular core network system of claim 13 wherein the destination entity comprises one of a destination media gateway, a destination call server, and a destination controller.

15. The cellular core network system of claim 13 wherein the ONSEA, the PNSEA, and the media gateway assigned VCC Identifier (VCCI) uniquely identifies the dynamic VCC between the source media gateway and the destination media gateway.

16. The cellular core network system of claim 8, wherein the cellular wireless core network comprises a UMTS R4 core network.

17. A distributed architecture dynamic signaling network comprises:
a plurality of call servers;
a plurality of media gateways (MGW), wherein each MGW is established as a signaling network endpoint having a unique signaling endpoint code;
a signaling network operably coupling the plurality of call servers and the plurality of media gateways;
a source call server and a destination call server operably coupled to service a call over a dynamic virtual circuit connection;
a source media gateway selected from the plurality of media gateways by a source entity, wherein the source media gateway generates an Originating Network Service Endpoint Address (ONSEA);
a destination media gateway selected from the plurality of media gateways by a destination entity, wherein the destination media gateway generates a Peer Network Service Endpoint Address (PNSEA); and
wherein the source media gateway and the destination media gateway establish the dynamic virtual circuit connection.

18. The distributed architecture dynamic signaling network of claim 17 wherein each media gateway of the plurality of media gateways comprises a plurality of cards, each card corresponding to a logical Asynchronous Transfer Mode (ATM) component having a unique ATM component address.

19. The distributed architecture dynamic signaling network of claim 18 wherein the source media gateway generated ONSEA uniquely identifies an originating logical ATM component address corresponding to an originating logical ATM component.

20. The distributed architecture dynamic signaling network of claim 19 wherein the destination media gateway generated PNSEA uniquely identifies a peer logical ATM component address corresponding to a peer logical ATM component.

21. The distributed architecture dynamic signaling network of claim 17 wherein the dynamic virtual circuit connection is uniquely defined by the ONSEA, PNSEA, and the media gateway generated Virtual Circuit Connection Identifier (VCCI).

22. The distributed architecture dynamic signaling network of claim 17 comprises one of a UMTS R4 core network and a wireline network.
